(19) United States
(12) Patent Application Publication
(10) Pub. No.: US 2021/0189951 A1
(43) Pub. Date: Jun. 24, 2021

(54) Thrust Vectoring Ignition Chamber Engine with Transverse Piston based Fuel Suction/Compression System

(71) Applicant: Ravi Shankar Gautam, Gaya (IN)

(72) Inventor: Ravi Shankar Gautam, Gaya (IN)

(21) Appl. No.: 17/262,732

(22) PCT Filed: Jul. 25, 2019
(86) PCT No.: PCT/IN2019/050543

§ 371 Date: Jan. 24, 2021

(30) Foreign Application Priority Data
Jul. 25, 2018 (IN) 201821027865

(51) Int. Cl. F02B 53/10; F02B 53/04

(52) U.S. Cl. CPC F02B 53/10; F02B 53/04

(57) ABSTRACT

This patent discloses thrust vectoring ignition chamber engine. Thrust vectoring ignition chamber used in this engine is an annular cylinder having nozzles mounted in a way such that during fuel suction phase they are sealed and during ignition of fuel they are unsealed so that hot jets of ignited fuel escaping through nozzles cause coupled rotatory motion on the ignition chamber. Engine uses cam operated two transverse piston based mechanism for suction and compression of fuel which facilitates separation of fuel valve from ignition chamber with the help of which combustion process and suction-compression process can occur simultaneously. Flywheel mounted on extension of ignition chamber functions as output of the engine. Each half rotation of flywheel completes three phases namely fuel/air suction, compression and combustion. Thus this engine fires for every half revolution and therefore can give improved power boost.

### FIELD OF INVENTION

The present disclosure relates generally to engine which can use petrol, diesel, compressed natural gas etc as fuel.

### BACKGROUND OF INVENTION

Automobiles have played significant role in enhancing human civilization by transporting agricultural products, construction material to build better homes etc. In automobile engines we need output which can rotate wheels. All automobile engines consist of cylindrical ignition chamber in which a piston is slip fit and is allowed to move back and forth at cylinder's rear end. Fuel-air mixture that ignition chamber received from an inlet valve (located at front end) is compressed and ignited to cause sudden expansion of gas which in turn causes thrust to the piston forcing in move rearwards. Connecting rods connecting the piston to crank shaft helps to convert translation motion of piston to rotatory motion of crankshaft which in turn causes flywheel (that is axially attached to crankshaft) to rotate. Flywheel causes wheel of automobile to rotate via transmission mechanism. One cycle of a four stroke engine for generating thrust from fuel consists of four phases namely fuel-air mixture suction, fuel-air mixture compression, ignition via spark plug (that causes thrust) and exhaust of burnt gas through exhaust valve located on the front end of ignition chamber. Each phase requires one strokes of piston and hence one cycle involves two rotations of crankshaft and therefore flywheel.

Around two centuries prior to the invention of modern day internal combustion chamber engine described above, two inventors Marcus Vitruvius Pollio (c. 80 BCE-c. 15 CE) from Rome and Hero (c. 10-70 CE) from Alexandria (Greece) had independently conceived of a steam engine named Aeolipile which was based on principle of thrust vectoring of steam enclosed in a chamber through transversely oriented nozzles. Automobile engine according to this invention is based on thrust vectoring concept which can also be seen in action in garden sprinkler, Catherine wheel, fighter jets etc.

### TECHNICAL PROBLEM

One of the drawbacks of four stroke engine is one phase of exhaust of burnt fuel gas is unproductive.

One of the drawbacks of four stroke engine is that it requires conversion of translation motion to rotatory motion for compression of fuel-air mixture as well as rotation of crankshaft.

One of the drawbacks of four stroke engine is that moving parts like inlet valves and exhaust valve comes in contact with ignited fuel gas mixture due to which it requires overhaul and maintenance. For example unmaintained valves may cause fuel backfire etc.

One of the drawbacks of four stroke engine is that it requires complex process and lot of moving parts to operate cam mechanisms for operating inlet and exhaust valves.

One of the drawbacks of two stroke engine is that exhaust gas and fuel gets mixed which causes lot of pollution.

### SUMMARY OF INVENTION

One of the objectives is to provide an engine which can directly convert fuel thrust to rotatory motion. This is achieved by thrust vectored exit of ignited fuel-air mixture. Ignited fuel-air mixture is bound to escape through pair of angled nozzles located at diametrically opposite sides of ignition chamber. Nozzles are angled with each nozzle making an acute angle with respect to outward radial direction. Difference between angles that nozzles make with the line joining them is 180 degree so that the exhaust of gas cause coupled torque on the ignition chamber.

In the engine, according to this invention, piston based compression mechanism have been retained to achieve high compression.

In the engine, according to this invention, each half rotation of flywheel completes three phases namely fuel/air suction, compression and combustion, instead of two rotations as required in engine according to prior art. Thus this engine improves power boost.

Engine, according to this invention, do not require a separate phase for exhaust of burnt gas and do not cause mixing of exhaust gas with fuel as well.

In the engine, according to this invention, ignition chamber directly operates the cam mechanism without involving large number of moving parts.

Engine, according to this invention, uses cam operated transverse piston based mechanism for suction and compression of fuel which facilitates separation of fuel valve from ignition chamber with the help of which combustion process and suction-compression process can occur simultaneously.

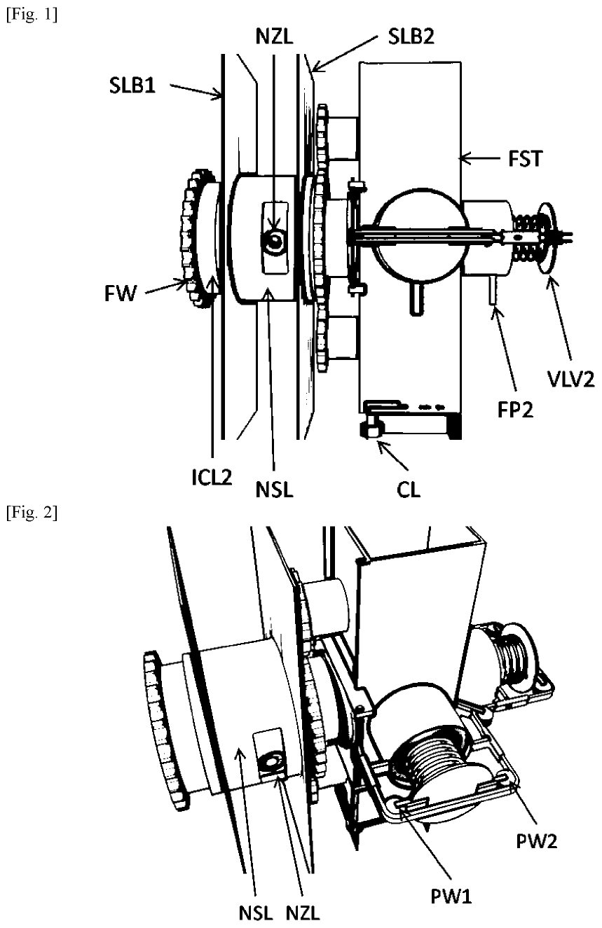

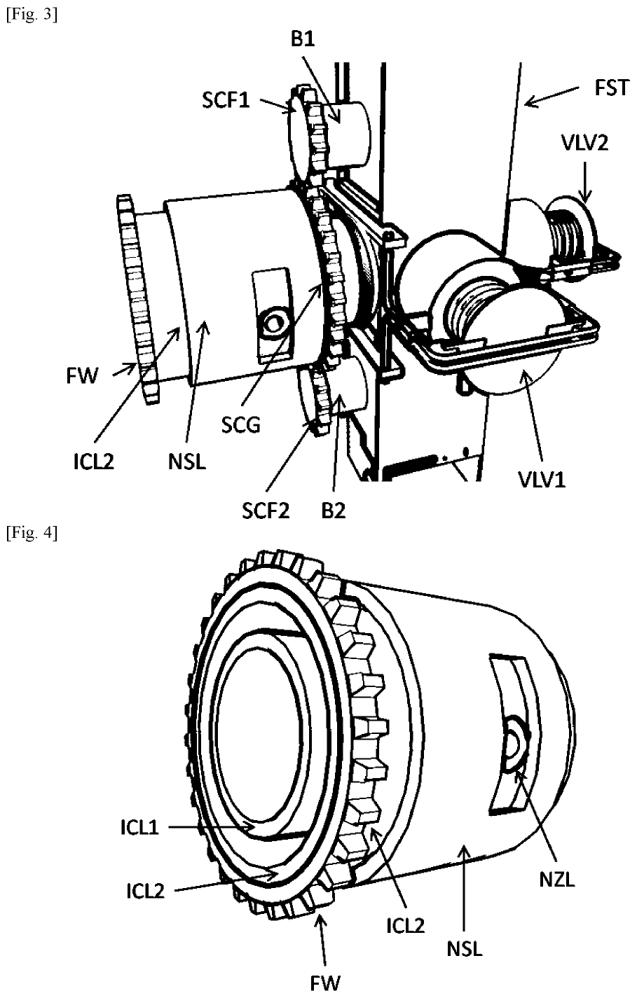

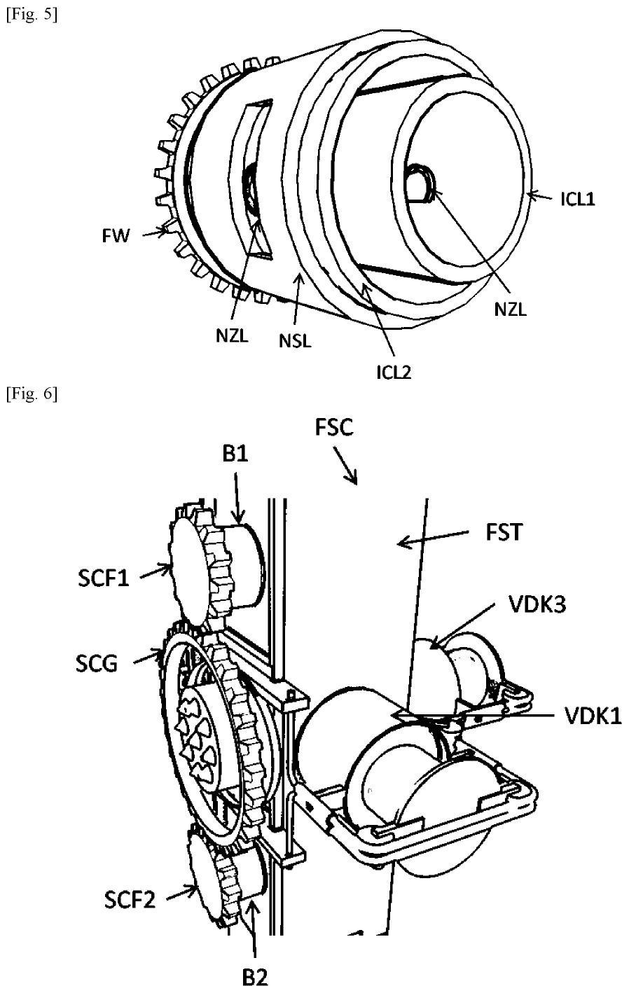

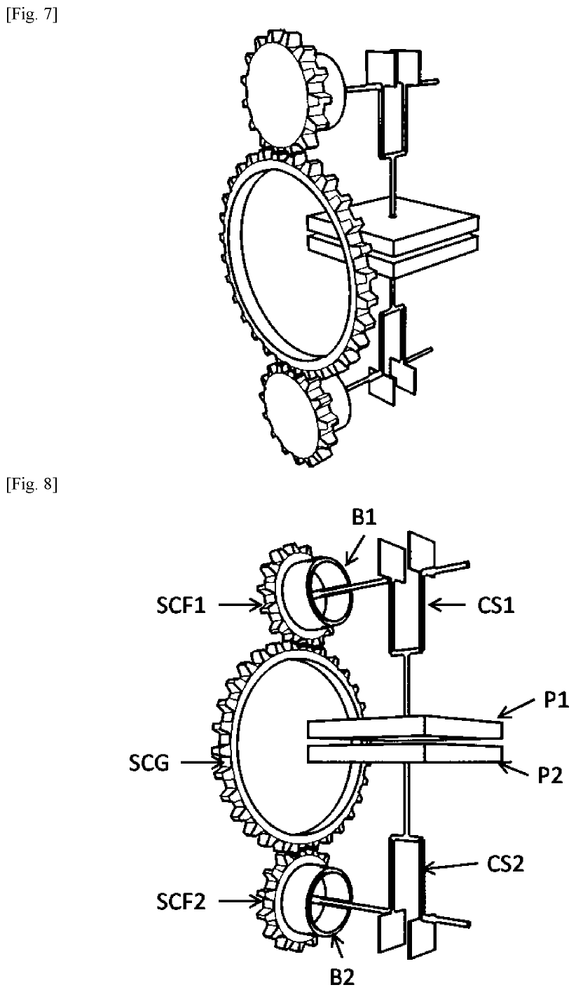

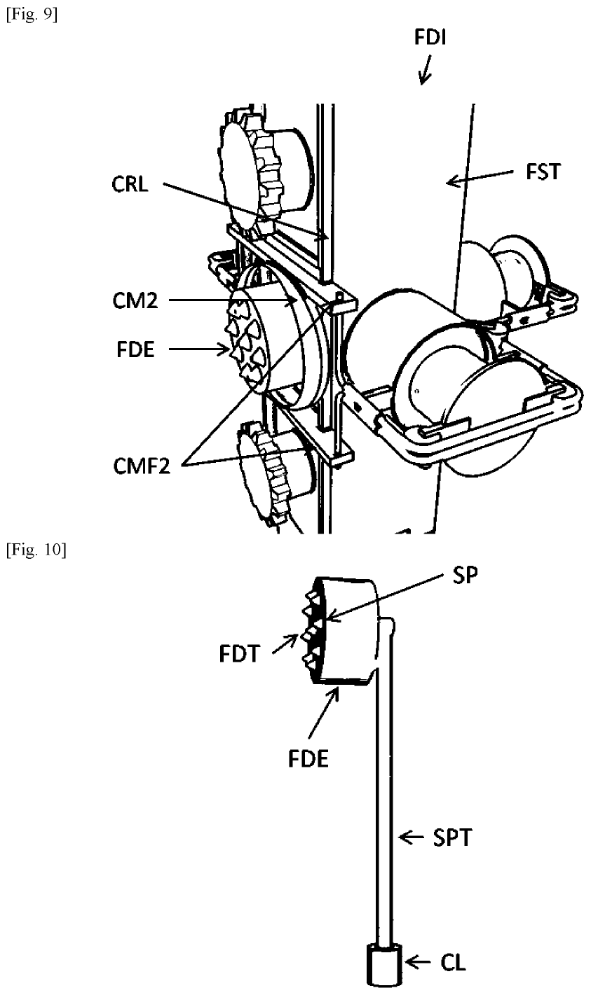

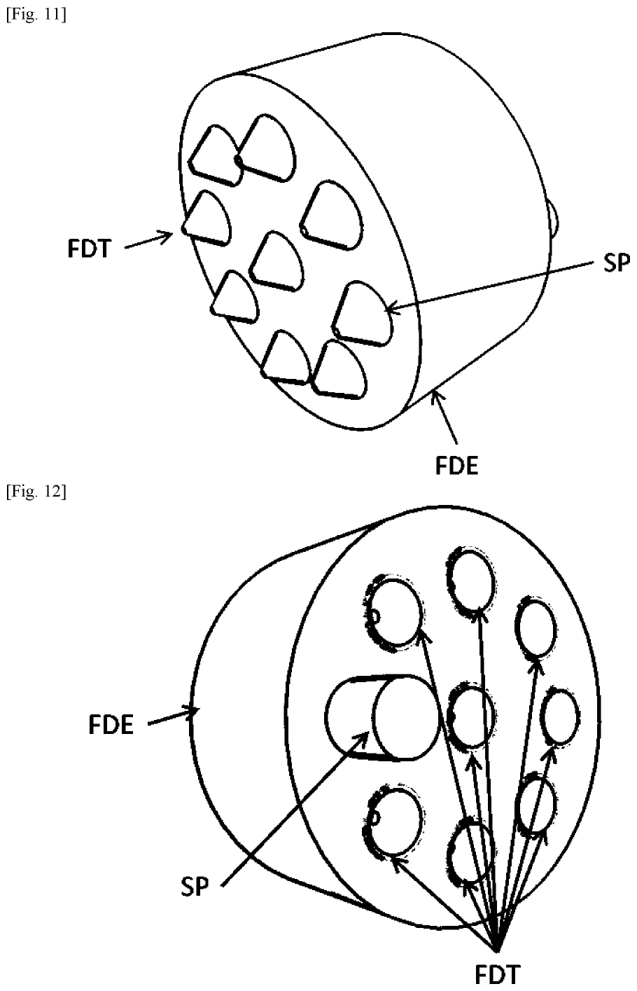

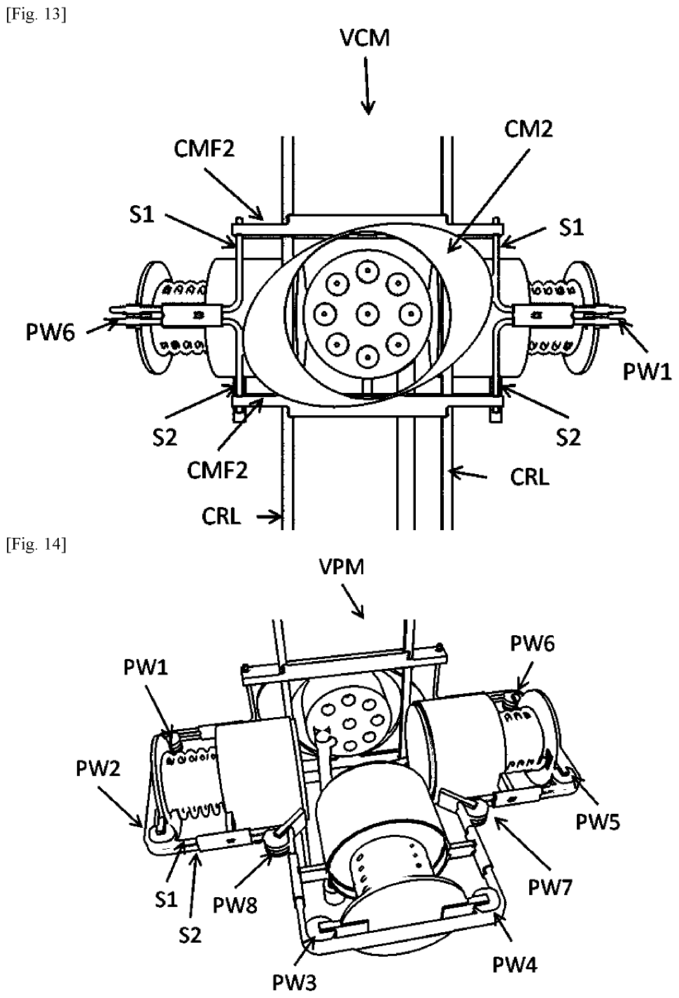

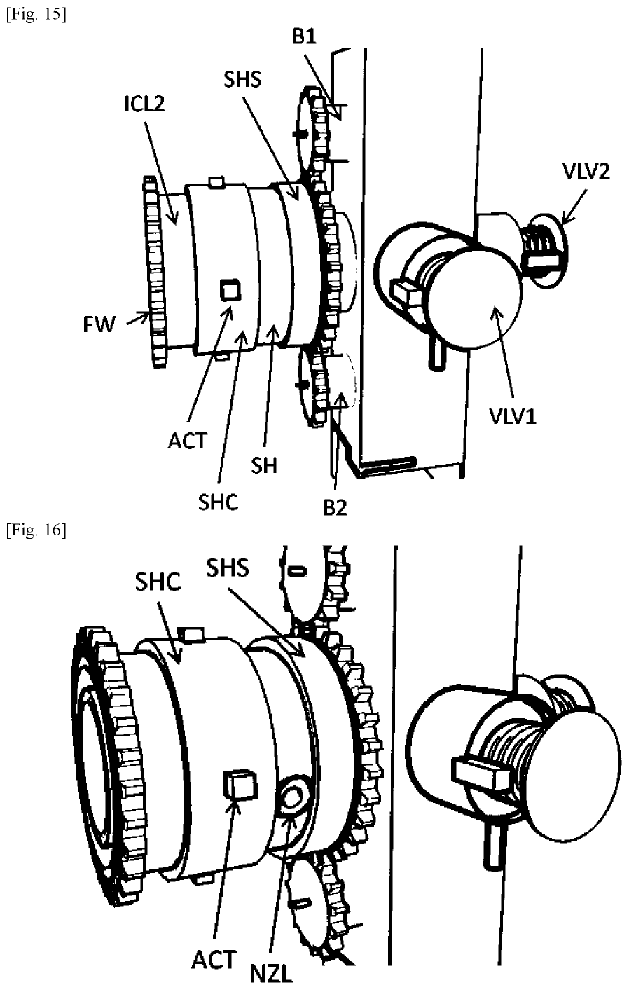

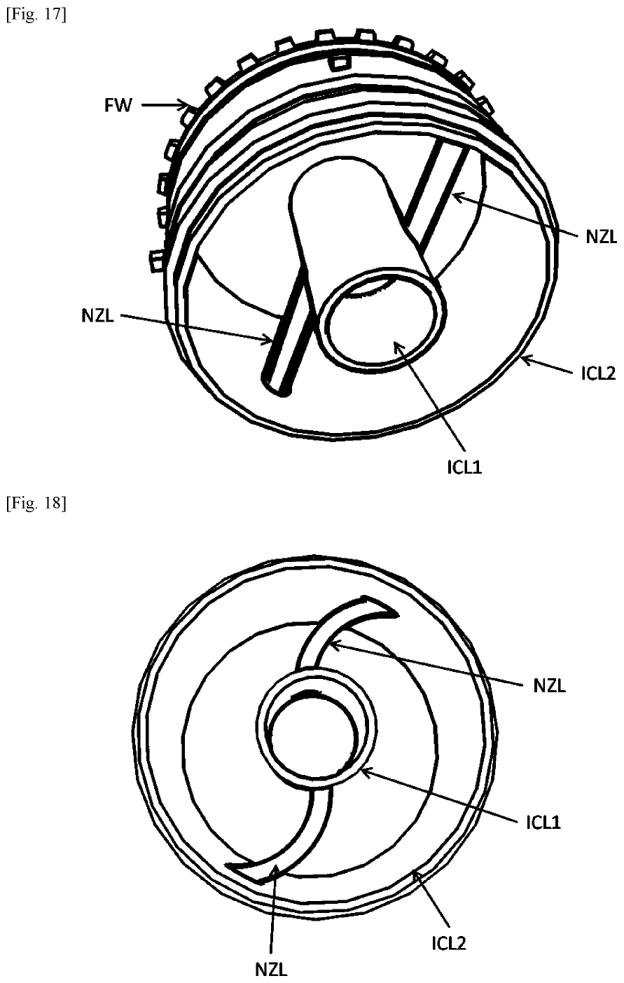

### BRIEF DESCRIPTION OF DRAWINGS

[FIG. 1] and [FIG. 2] Side and top view of thrust vectoring ignition chamber engine with engine support mechanism according to this invention

[FIG. 3] Closeup view of thrust vectoring ignition chamber engine according to this invention

[FIG. 4] and [FIG. 5] Front and rear view thrust vectoring ignition chamber of the engine according to this invention

[FIG. 6], [FIG. 7] and [FIG. 8] Fuel suction and compression system

[FIG. 9] to [FIG. 14] Fuel delivery and ignition mechanism

[FIG. 10] Fuel delivery enclosure with spark plug tube and ignition coil

[FIG. 11] and [FIG. 12] Front and rear view of fuel delivery enclosure

[FIG. 13] and [FIG. 14] Valve cam mechanism and valve pulley mechanism

[FIG. 15] and [FIG. 16] Variation of thrust vectoring ignition chamber engine with electrically control mechanism for nozzle seal and solenoid coil fuel valve

[FIG. 17] Nozzle as pair of (right) conical tube.

[FIG. 18] Nozzle as pair of curved tubes.

### DESCRIPTION OF EMBODIMENTS

Referring to [FIG. 1], the preferred embodiment of an automobile engine (1) according to this invention is shown to include an engine enclosure (ENC), thrust vectoring ignition chamber (IC), fuel suction and compression system (FSC), fuel delivery and ignition mechanism (FDI), nozzle seal (NSL), and flywheel (FW).

Engine enclosure (ENC), as shown in [FIG. 1] and [FIG. 2], appropriately secures all parts of engine, provides support to engine via rectangular slabs (SLB1) and (SLB2) attached to outer static parts of engine like nozzle seal and fuel supply shaft of fuel suction and compression system and provides exit to the burnt fuel gas via exhaust pipe.

Thrust vectoring ignition chamber (IC), as shown in [FIG. 4] and [FIG. 5], consists of a pair of coaxial annular cylinders, an inner annular cylinder (ICL1) and an outer annular cylinder (ICL2), connected coaxially via coaxial rings (IR), and coupled thrust vectoring nozzle (NZL) wherein
inner annular cylinder (ICL1) is coaxially fixedly caped at front side by ignition chamber seal (ICS), which is a circular disk;
fuel suction and compression system (FSC) and fuel delivery and ignition mechanism (FDI) are mounted on rear side of the ignition chamber;
coupled thrust vectoring nozzle (NZL), as shown in FIG. 17, is a pair of conical tubes mounted at diametrically opposite points on the right circular section on the middle part of ignition chamber by passing through holes on the inner annular cylinder (ICL1) and outer annular cylinder (ICL2) such that one end with bigger aperture opens inside the inner annular cylinder (ICL1) and other end with smaller aperture opens on the outer side of outer annular cylinder (ICL2);
each tube make equal acute angle with respect to radially outward direction in opposite direction along the right circular section of ignition chamber;
surface of the nozzles on the outer side of ignition chamber are cut to take the shape of outer surface of the outer annular cylinder (ICL2) so that ignition chamber can glide inside the nozzle seal cylinder smoothly and surface of the nozzles on the inner side of ignition chamber are cut to take the shape of inner surface of the inner annular cylinder (ICL1);
ignition chamber (IC) extends towards rear side of the nozzle wherein its inner annular cylinder (ICL1) extends longer than the outer annular cylinder (ICL2) towards the rear side.

Nozzle seal (NSL), as shown in [FIG. 4] and [FIG. 5], used to seal and unseal nozzle (NZL), is an annular cylinder which holds outer annular cylinder (ICL2) of the ignition chamber via ball bearing such that
its middle portion falls above the nozzle (NZL);
its length is such that outer annular cylinder (ICL2) is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
thrust vectoring nozzle (NZL) remain sealed except when passes under gas exiting holes of nozzle seal (NSL).

Fuel suction and compression system (FSC), as shown in [FIG. 6], [FIG. 7] and [FIG. 8], which is designed to suck fuel-air mixture and pump it to the ignition chamber in the compressed form, consists of fuel supply shaft (FST), fuel suction cam gear (SCG), upper ball bearing (B1), lower ball bearing (B2), upper fuel suction cam follower gear (SCF1), lower fuel suction cam follower gear (SCF2), upper crank shaft (CS1), lower crank shaft (CS2), upper piston (P1) and lower piston (P2) wherein
fuel supply shaft (FST), a vertical rectangular tube capped at its upper end and attached at its lower end to engine enclosure floor, has a cylindrical deck at its front, left, right and rear side, at its middle portion;
fuel suction cam gear (SCG), an externally teethed annular circular gear, is coaxially mounted on the rearward extension of the outer annular cylinder of the ignition chamber;
upper suction cam follower gear (SCF1) and lower suction cam follower gear (SCF2) are externally teethed spur gear each of radius equal to half the radius of fuel suction cam gear (SCG) and mounted on upper ball bearing (B1) and lower ball bearing (B2), respectively, which in turn are mounted on upper and lower portion (with respect to front deck of fuel supply shaft), respectively, of outer side of the front wall of the fuel supply shaft (FST);
ball bearings (B1) and (B2) are appropriate length such that teeth of the upper and lower cam follower meshingly engages with teeth of fuel suction cam gear;
upper crank shaft (CS1) and lower crank shaft (CS2) are single pin crank shafts horizontal mounted inside fuel shaft (FST) on its upper and lower portion, respectively, such that main bearing shaft is journalled to the rear wall and flywheel shaft extends out of front wall to coaxially connect to the center of upper cam follower gear (SCF1) and lower cam follower gear (SCF2), respectively, such that respective cam follower gear works as flywheel for the crankshafts;
upper piston (P1) and lower piston (P2) are horizontal plates of dimensions such that it slip fits inside fuel supply shaft (FST) on upper and lower portion, respectively, and are connected crankpins of upper crank shaft (CS1) and lower crank shaft (CS2), respectively, via connecting rods.

Fuel delivery and ignition mechanism (FDI), as shown in [FIG. 9] to [FIG. 14], consists of a fuel supply enclosure (FDE), a cluster of six fuel-air delivery tubes (FDT) and spark-plug (SP), spark-plug holding tube (SPT), ignition coil (CL). three air-fuel valve, namely left valve (VLV1), right valve (VLV2), rear valve (VLV3), fuel valve open-close cam mechanism (VCM) wherein
left valve (VLV1), right valve (VLV2) and rear valve (VLV3) are push-to-open valves housed in cylindrical decks on left, right and rear sides, respectively, of fuel supply shaft such that they open inside fuel shaft (FST);
fuel delivery enclosure (FDE), is an horizontal solid cylinder with six-seven holes is sealingly attached at its rear end to the front side hole on fuel shaft (FST) wherein one hole at left most point of the enclosure, (FDE), houses spark-plug;
all other holes have valve at both ends with both valve opening at their front side thus forming cluster of fuel delivery tubes (FDT);
spark-plug holding tube (SPT), is a L-shaped cylindrical tube with one arm being horizontal is fixedly sealingly coaxially attached to the right most holes of the front and rear cap of the fuel delivery enclosure (FDE) and other arm extending vertically downward is sealingly coaxially attached to the hole in the piston stopper to lead to ignition coil (CL) located at the lower end of fuel supply shaft (FST);
fuel valve open-close cam mechanism (VCM) is a special cam mechanism located between suction cam gear (SCG) and fuel supply shaft (FST) used to operate three fuel valves.

Fuel valve open-close cam mechanism (VCM), as shown in [FIG. 13] , consists of an fuel switch cam (CM2), cam railings (CRL) on the front two edges on outer side of fuel shaft, valve pulley mechanism (VPM), fuel switch cam follower (CMF2), wherein
fuel switch cam (CM2), is an elliptical wheel which is mounted coaxially on the rear side of inner cylinder of ignition chamber extending out on the rear side close to the front side of fuel supply shaft;
fuel switch cam follower (CMF2), is a pair of slabs that is mounted at their rear side on the railings (CRL), mentioned above so that it can slide in vertical direction with front side of the slabs lying above the above said fuel switch cam (CM2).

Valve pulley mechanism (VPM), as shown in [FIG. 14] , consists of eight pairs of pulley wheels (PW1), (PW2), (PW3), (PW4), (PW5), (PW6), (PW7), (PW8), a pair of strings, upper string (S1) and lower string (S2), string retaining mechanism (SRM) wherein
string retaining mechanism (SRM) consists of six pairs of horizontal tubes each attached on its outer surface to either horizontal side of a cylindrical decks on the fuel supply shaft lofted away in horizontal direction from the valve body with one tube in each pair lying below the other;
spring retainer of the each valve has a pair of pulley wheels attached at one extreme point along horizontal plane and other pair is attached at diametrically opposite point with one pulley wheel in each pair lies below the other and upper pulley wheels and lower pulley wheels are at the same height as upper and lower string retaining tubes respectively;
rear edge on the outer side of fuel supply shaft (FST) is attached with a pair pulley wheels such that they are at same height as other pairs of pulley wheels;
upper string (S1) passes through upper pulley wheels of each pair and upper string retaining tubes in a serial manner with right and left end fixedly connected to right and left end respectively of upper slab of cam follower (CMF2);
lower string (S2) passes through lower pulley wheels of each pair and lower string retaining tubes serial manner with right and left end fixedly connected to right and left end respectively of lower slab of cam follower (CMF2).

Flywheel (FW), as shown in [FIG. 1] and [FIG. 2], is an externally teethed circular annular gear that functions as output of the engine and is mounted coaxially to the front side extension of outer cylinder of ignition chamber.

Thrust vectored ignition chamber engine described above is an engine which can use petrol as fuel and in order to use diesel as a fuel we need to replace spark plug with pressure valve, ignition coil with fuel source, air-fuel valve with air valve.

According to one variation to above description, nozzle seal (NSL), which dynamically puts nozzle (NZL) into closed or open phase, as shown in [FIG. 15] and [FIG. 16], consists of three annular cylinders, namely shutter cavity (SHC), shutter (SH) and shutter stopper (SHS), coaxially mounted on outer side of outer cylinder of ignition chamber near nozzle (NZL) and a push-pull solenoid actuator (ACT), wherein
shutter cavity (SHC) is a special type of annular cylinder, whose front portion coaxially holds the outer annular cylinder of ignition chamber (ICL2) with the help of a ball bearing but the rear portion (which is facing nozzle) forms an annular cylindrical cavity with outer annular cylinder of ignition chamber (ICL2) which can house shutter (SH);
shutter (SH) is an annular cylinder coaxially mounted to the rear portion of the shutter cavity (SHC) such that outer annular cylinder of ignition chamber (ICL2) slip fits inside the shutter (SH) and shutter (SH) can be operated by actuator (ACT) to slide in and out of cylindrical annular cavity on the rear portion of shutter cavity (SHC) to unseal and seal the nozzles (NZL) respectively;
shutter stopper (SHS) is an annular cylinder located on the rear side of nozzles (NZL), which coaxially holds the outer annular cylinder of ignition chamber (ICL2), via one or more coaxial ball bearings and to helps to stop shutter (SH) from sliding away;
push-pull actuator (ACT) consists of three-four solenoid coils mounted on the outer side shutter cavity (SHC), which operates the shutter (SH) and works to push and pull the shutter (SH) to slide in and slide out of the cylindrical annular cavity on the rear portion of shutter cavity (SHC);
shutter cavity (SHC), and shutter stopper (SHS) are secured to enclosure (ENC) by rectangular slabs.

According to another variation to above description, thrust vectoring nozzle (NZL), as shown in [FIG. 18], consists of pair of curved conical tubes so that escape angle of gas at outer surface of outer cylinder (ICL2) of ignition chamber can be closer to tangent of circle described by nozzles with aperture of nozzles inside the inner cylinder (ICL1) of ignition chamber, is along radial direction.

According to another variation to above description, instead of using three air-fuel valve we may use only one air-fuel valve operated by solenoid coil and left and right valve be replaced by horizontal fuel suction-compression mechanism similar to vertical fuel suction-compression mechanism as described above.

### Engine Operation for Stationary Nozzle Seal

Each half rotation of ignition chamber and therefore flywheel is divided into two phases namely suction phase, compression phase and combustion phase. Suction phase occurs during the combustion phase. In the combustion phase compressed fuel in the ignition chamber is ignited causing rotatory thrust to the ignition chamber due to air exhaust through nozzles. During combustion phase, that is one fourth of rotatory motion of ignition chamber rotatory motion is converted into transverse translation motion of piston inside the fuel shaft using crankshaft mechanism causing oppositely facing suction pistons to move away from center of fuel shaft and at the same time tip of longer lobe of fuel cam wheel pushes fuel cam followers vertically away from the air passage tube causing the fuel valve to open and thus resulting in suction of air-fuel mixture into fuel shaft. During the compression phase (following combustion phase) that is next one fourth of rotatory motion of ignition chamber fuel cam releases fuel cam followers sufficiently so that fuel valve come is closed phase and at the same time rotatory motion suction cam followers causes the oppositely facing pistons to return to the center of fuel shaft thus causing the compressed air-fuel mixture to rush into the ignition chamber. Fuel valves do not come in contact with combustion chamber. Since fuel suction and fuel combustion mechanisms are decoupled, fuel suction and combustion can happen simultaneously. Also a separate phase to expel burnt gas is not required.

1. A rotary automobile engine with cross-axis reciprocating fuel suction and compression system, with fuel suction and compression system separated from fuel combustion process, for directly converting the fuel energy to rotatory motion using thrust vectoring of ignited fuel, consisting of an engine enclosure, thrust vectoring ignition chamber, fuel suction and compression system, fuel delivery and ignition mechanism, nozzle seal and flywheel.

2. Engine enclosure, claimed in [claim 1], appropriately secures all parts of engine, provides support to engine via rectangular slabs attached to outer static parts of engine like nozzle seal and fuel supply shaft of fuel suction and compression system, claimed in [claim 1], and provides exit to the burnt fuel gas via exhaust pipe.

3. Thrust vectoring ignition chamber, claimed in [claim 1], consists of a pair of coaxial annular cylinders, an inner annular cylinder and an outer annular cylinder, connected coaxially via coaxial rings, and coupled thrust vectoring nozzle wherein
inner annular cylinder is coaxially fixedly caped at its front side by ignition chamber seal which is a circular disk;
fuel suction and compression system and fuel delivery and ignition mechanism are mounted on rear side of the ignition chamber;
coupled thrust vectoring nozzle is a pair of conical tubes mounted at diametrically opposite points on the right circular section on the middle part of ignition chamber by passing through holes on the inner annular cylinder and outer annular cylinder such that one end with bigger aperture opens inside the inner annular cylinder and other end with smaller aperture opens on the outer side of outer annular cylinder;
each tube make equal acute angle with respect to radially outward direction in opposite direction along the right circular section in middle portion of ignition chamber;
surface of the nozzles on the outer side of ignition chamber are cut to take the shape of outer surface of the outer cylinder so that ignition chamber can glide inside the nozzle seal cylinder smoothly and surface of the nozzles on the inner side of ignition chamber are cut to take the shape of inner surface of the inner annular cylinder;
ignition chamber extends towards rear side of the nozzle wherein its inner annular cylinder extends longer than the outer annular cylinder towards the front side.

4. Nozzle seal, claimed in [claim 1], used to seal and unseal nozzle, is an annular cylinder which holds outer annular cylinder of the ignition chamber via ball bearing such that
its middle portion falls above the nozzle;
its length is such that outer annular cylinder is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
above mentioned rectangular holes are such that thrust vectoring nozzle remain sealed except for time interval during which highly pressurized ignited gas is scheduled to pass through it to cause rotary thrust on the ignition chamber.

5. Fuel suction and compression system, claimed in [claim 1], which is designed to suck fuel-air mixture and pump it to the ignition chamber in the compressed form, consists of fuel supply shaft, fuel suction cam gear, upper ball bearing, lower ball bearing, upper fuel suction cam follower gear, lower fuel suction cam follower gear, upper crank shaft, lower crank shaft, upper piston and lower piston wherein
fuel supply shaft, a vertical rectangular tube capped at its upper end and attached at its lower end to engine enclosure floor, has a cylindrical deck at its front, left, right and rear side, at its middle portion;
fuel suction cam gear, an externally teethed annular circular gear, is coaxially mounted on the rearward extension of the outer annular cylinder of the ignition chamber;
upper suction cam follower and lower suction cam follower are externally teethed spur gear each of radius equal to half the radius of fuel suction cam gear and mounted on upper ball bearing and lower ball bearing, respectively, which in turn are mounted on upper and lower portion (with respect to fuel delivery enclosure), respectively, of outer side of the front wall of the fuel shaft;
ball bearings are appropriate length such that teeth of the upper and lower cam follower meshingly engages with teeth of fuel suction cam gear;
upper crank shaft and lower crank shaft are single pin crank shafts horizontal mounted inside fuel supply shaft on its upper and lower portion, respectively, such that main bearing shaft is journalled to the rear wall and flywheel shaft extends out of front wall to coaxially connect to the center of upper cam follower gear and lower cam follower gear, respectively, such that respective cam follower gear works as flywheel for the crankshafts;
upper piston and lower piston are horizontal plates of dimensions such that it slip fits inside fuel supply shaft on upper and lower portion, respectively, and are connected crankpins of upper crank shaft and lower crank shaft, respectively, via connecting rods.

6. Fuel delivery and ignition mechanism, claimed in [claim 1], consists of a fuel supply enclosure, a cluster of six fuel-air delivery tubes and spark-plug, spark-plug holding tube, ignition coil, three air-fuel valve, namely left valve , right valve, rear valve, fuel valve open-close cam mechanism wherein
left valve, right valve and rear valve are push-to-open valves housed in cylindrical decks on left, right and rear sides, respectively, of fuel supply shaft such that they open inside fuel shaft;
fuel delivery enclosure, is an horizontal solid cylinder with six-seven holes is sealingly attached at its rear end to the front side hole on fuel shaft wherein one hole at left most point of the enclosure houses spark-plug;
all other holes have valve at both ends with both valve opening at their front side thus forming cluster of fuel delivery tubes;
spark-plug holding tube, is a L-shaped cylindrical tube with one arm being horizontal is fixedly sealingly coaxially attached to the right most holes of the front and rear cap of the fuel delivery enclosure and other arm extending vertically downward is sealingly coaxially attached to the hole in the piston stopper to lead to ignition coil located at the lower end of fuel supply shaft;
fuel valve open-close cam mechanism is a special cam mechanism located between suction cam gear and fuel supply shaft used to operate three fuel valves.

7. Fuel valve open-close cam mechanism, claimed in [claim 6], consists of an fuel switch cam, cam railings on the front two edges on outer side of fuel shaft, valve pulley mechanism, fuel switch cam follower, wherein
fuel switch cam is an elliptical wheel which is mounted coaxially on the rear side of inner cylinder of ignition chamber extending out on the rear side close to the front side of fuel supply shaft;
fuel switch cam follower, is a pair of slabs that is mounted at their rear side on the railings, mentioned above so that it can slide in vertical direction with front side of the slabs lying above the above said fuel switch cam.

8. Valve pulley mechanism, mentioned in [claim 7], consists of eight pairs of pulley wheels, a pair of strings namely upper string and lower string, string retaining mechanism wherein
string retaining mechanism consists of six pairs of horizontal tubes each attached on its outer surface to either horizontal side of a cylindrical decks on the fuel supply shaft lofted away in horizontal direction from the valve body with one tube in each pair lying below the other;
spring retainer of the each valve has a pair of pulley wheels attached at one extreme point along horizontal plane and other pair is attached at diametrically opposite point with one pulley wheel in each pair lies below the other and upper pulley wheels and lower pulley wheels are at the same height as upper and lower string retaining tubes respectively;
rear edge on the outer side of fuel supply shaft is attached with a pair pulley wheels such that they are at same height as other pairs of pulley wheels;
upper string passes through upper pulley wheels of each pair and upper string retaining tubes in a serial manner with right and left end fixedly connected to right and left end respectively of upper slab of cam follower mentioned in [claim 7];
lower string passes through lower pulley wheels of each pair and lower string retaining tubes serial manner with right and left end fixedly connected to right and left end respectively of lower slab of cam follower mentioned in [claim 7].

9. Flywheel, mentioned in [claim 1], is an externally teethed circular annular gear that functions as output of the engine and is mounted coaxially to the front side extension of outer cylinder of ignition chamber.

10. Thrust vectored ignition chamber engine described above is an engine which can use petrol as fuel and in order to use diesel as a fuel we need to replace spark plug with pressure valve, spark plug tube with a pipe that connected to fuel source, ignition coil with fuel source, air-fuel valve with air valve.

11. According to one variation to above description, nozzle seal mentioned in [claim 1], which dynamically puts nozzle into closed or open phase, consists of three annular cylinders, namely shutter cavity, shutter and shutter stopper, coaxially mounted on outer side of outer cylinder of ignition chamber near nozzle and a push-pull solenoid actuator, wherein
shutter cavity is a special type of annular cylinder, whose front portion coaxially holds the outer annular cylinder of ignition chamber with the help of a ball bearing but the rear portion (which is facing nozzle) forms an annular cylindrical cavity with outer annular cylinder of ignition chamber which can house shutter;
shutter is an annular cylinder coaxially mounted to the rear portion of the shutter cavity such that outer annular cylinder of ignition chamber slip fits inside the shutter and shutter can be operated by actuator to slide in and out of cylindrical annular cavity on the rear portion of shutter cavity to unseal and seal the nozzles respectively;
shutter stopper is an annular cylinder located on the rear side of nozzles, which coaxially holds the outer annular cylinder of ignition chamber, via one or more coaxial ball bearings and to helps to stop shutter from sliding away;
push-pull actuator consists of three-four solenoid coils mounted on the outer side of shutter cavity, which operates the shutter and works to push and pull the shutter to slide in and slide out of the cylindrical annular cavity on the rear portion of shutter cavity;
push-pull actuator is timed in a way that it put the nozzle in open state only at the end of ignition phase when compressed fuel gas is ignited and raised to a sufficient pressure to cause considerable rotary thrust upon exit through nozzle and put the nozzle in closed state after the ignited gas has exited through nozzle;
shutter cavity, and shutter stopper are secured to engine enclosure by rectangular slabs.

12. According to another variation to above description, thrust vectoring nozzle consists of pair of curved conical tubes so that escape angle of gas at outer surface of outer annular cylinder of ignition chamber can be closer to tangent of circle described by nozzles with aperture of nozzles inside the inner annular cylinder of ignition chamber, is along radial direction.

13. According to another variation to above description, all three valves are operated by solenoid coils which will significantly reduce number of moving parts.

14. According to another variation to above description, instead of using three air-fuel valve we may use only one air-fuel valve located on rear side fuel shaft and that can be operated by solenoid coil and left and right valve be replaced by horizontal fuel suction-compression mechanism similar to vertical fuel suction-compression mechanism as described above.
